(19) United States
(12) Patent Application Publication
(10) Pub. No.: US 2013/0233107 A1
(43) Pub. Date: Sep. 12, 2013

(54) Gear Train

(71) Applicants: Kaspar Freiherr Von Wilmowsky, Donauworth (DE); Andreas Fuchs, Pfronten-Ried (DE); Jens Kunze, Bad Hindelang (DE)

(72) Inventors: Kaspar Freiherr Von Wilmowsky, Donauworth (DE); Andreas Fuchs, Pfronten-Ried (DE); Jens Kunze, Bad Hindelang (DE)

(21) Appl. No.: 13/816,719

(22) PCT Filed: Jul. 26, 2011
(86) PCT No.: PCT/EP11/03731

§ 371 Date: May 24, 2013

(30) Foreign Application Priority Data
Sep. 2, 2010 (DE) 10 2010 036 141.0

(51) Int. Cl. F16H 57/04; F16H 57/02

(52) U.S. Cl. CPC F16H 57/046; F16H 57/02
USPC 74/421 R

(57) ABSTRACT

The invention relates to a liquid-lubricated gear train having the following characteristics: the gear train has at least two gears, the teeth of which mesh with each other; the gear train has an engagement area, which has an inlet and an outlet; the gear train has a casing wall, which encloses at least one of two gears that work with each other and partially or completely blocks the enclosed interior off from the environment; the casing wall has an outlet in the area of the inlet, wherein said outlet establishes a conducting connection between the interior and the atmosphere; and the distance between the dynamic enveloping circle of the gears and the casing wall is less than the tooth height.

The invention relates to a gear train with two or more gearwheels which respectively mesh with one another. Further elements of such a gear train are shafts, bearings and a housing. Such gear trains are liquid-lubricated and generally lubricated with oil

Considerable quantities of the medium encompassing the gearwheels will be moved and revolved in a turbulent fashion in the gear housing especially in the case of high-speed gears in turbo or railway gears. This usually concerns a two-phase mixture consisting of air and oil with a considerably higher air volume fraction.

In order to mainly cool the tooth contacts and to also maintain an oil film/lubrication film between the contact partners, the gearwheels are provided with an oil injection.

Depending on the oil injection, this leads both to a pressure difference between the tooth engagement and tooth exit without any noticeable influence on the ventilation losses, and to a conveying effect on the ambient medium depending on the circumferential speed on the gearing.

The aforementioned revolving of the medium in the conventional gears leads to a considerable energy loss by ventilation, i.e. ventilation losses.

Gear pumps usually consist of two mutually meshing gearwheels with the same number of teeth which comprise an extremely tightly contacting casing wall about the gearwheels with an inlet in the tooth exit and an outlet in the tooth entrance. As a result of the tightly contacting casing wall, a differential pressure builds up between the tooth exit and the tooth entrance. They are used for the purpose of conveying a fluid medium from the inlet to the outlet.

In comparison with gear pumps, conventional high-speed spur gears are provided with relatively large bearing plays for the transmission of high power and with long tolerance chains as a result of the large number of components. That is why it is not possible to a use a conventional high-speed spur gear effectively as a gear pump, especially for conveying gaseous media, without any special sealing measures because too large gaps would occur.

It is known to aspirate a gear by applying a negative pressure to the gear housing. Special efforts are necessary such as pumps, additional tubing, etc. This system is expensive and susceptible to malfunctions. It is also known that respective safeguarding measures need to be taken when insufficient negative pressure can be generated in the gear housing.

The invention is based on the object of providing a gear in which the ventilation losses are minimized or eliminated.

This object is achieved by the features of claim 1.

Such a gear has the following features:
a casing wall which encloses at least one of two mutually cooperating gearwheels and blocks off the enclosed inside space against the ambient environment;
the casing wall comprises an outlet in the region of the tooth entrance which produces a conductive connection between the inside space and the atmosphere;
the distance between the addendum circle (tip circle) of the gearwheels and the casing wall is smaller than the height of the teeth.

This leads to the following advantages:
ventilation losses are reduced or avoided;
the efficiency of the gear is higher and the power loss is accordingly lower;
the advantages are achieved with a minimal constructional effort;
there are no operating or maintenance problems;
there are no additionally necessary safety systems or measures;
no external efforts need to be undertaken to generate negative pressure.

The casing wall can also be cooled via a medium such as water by cooling channels in a water circuit. The required quantity of oil for cooling the gearwheels can be reduced even further and the ventilation losses can be reduced.

The invention will be explained in closer detail by reference to the drawings, which show in detail:

FIG. 1 shows a gear with two gearwheels, a casing wall which completely encloses said gearwheels, and a negative-pressure space and an overpressure space;

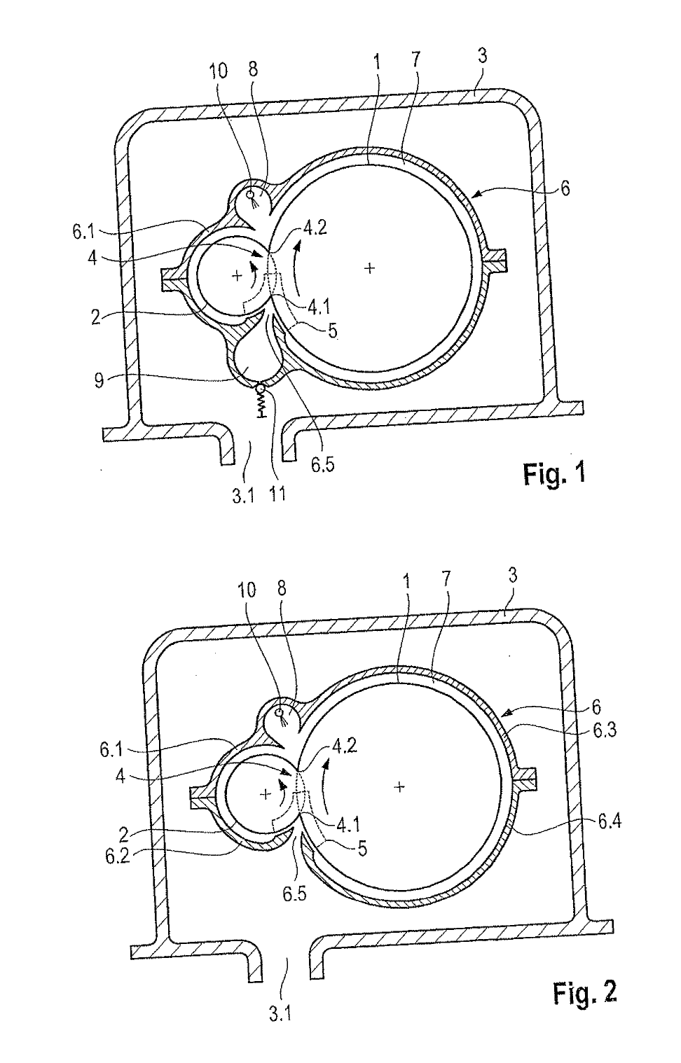

FIG. 2 shows a gear similar to the one according to Fig, 1, but without an overpressure space;

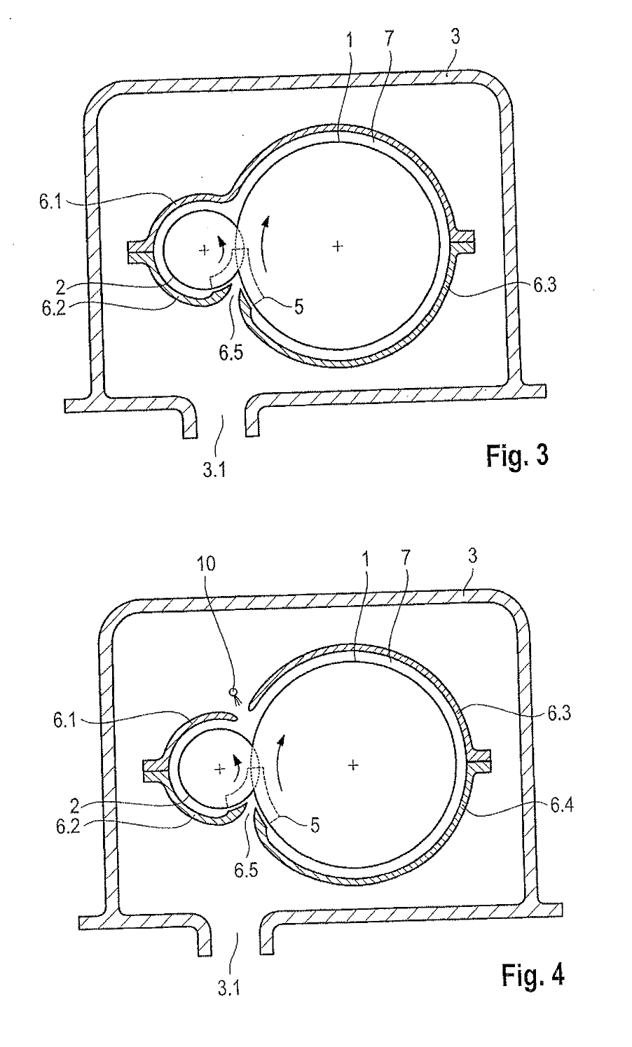

FIG. 3 shows a gear similar to the one of FIG. 1, but without a negative-pressure space and without an overpressure space;

FIG. 4 shows a gear similar to the one according to FIG. 3, but with separated casing walls for the two gearwheels;

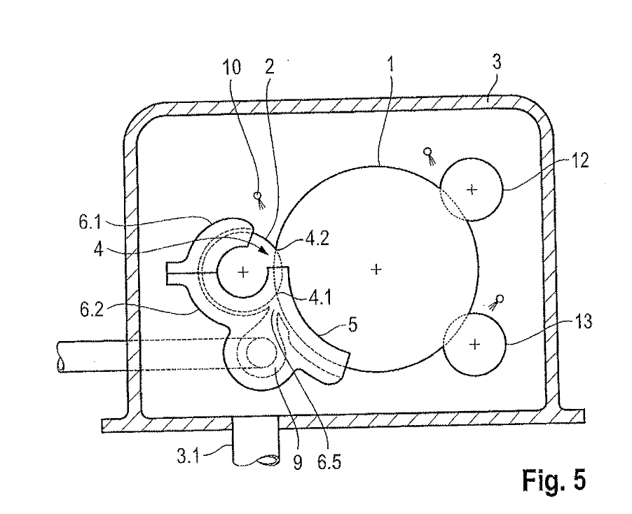

FIG. 5 shows a gear train with a planet wheel and three pinions, and further with an overpressure space;

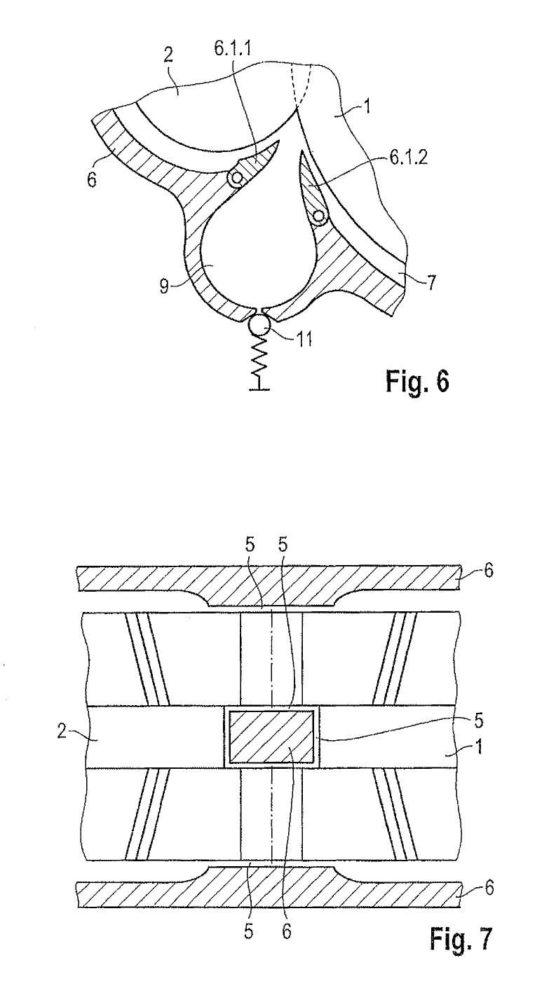

FIG. 6 shows two gearwheels with a casing wall which comprises pivotable flaps;

FIG. 7 shows a gear in a cylindrical section with two gearwheels;

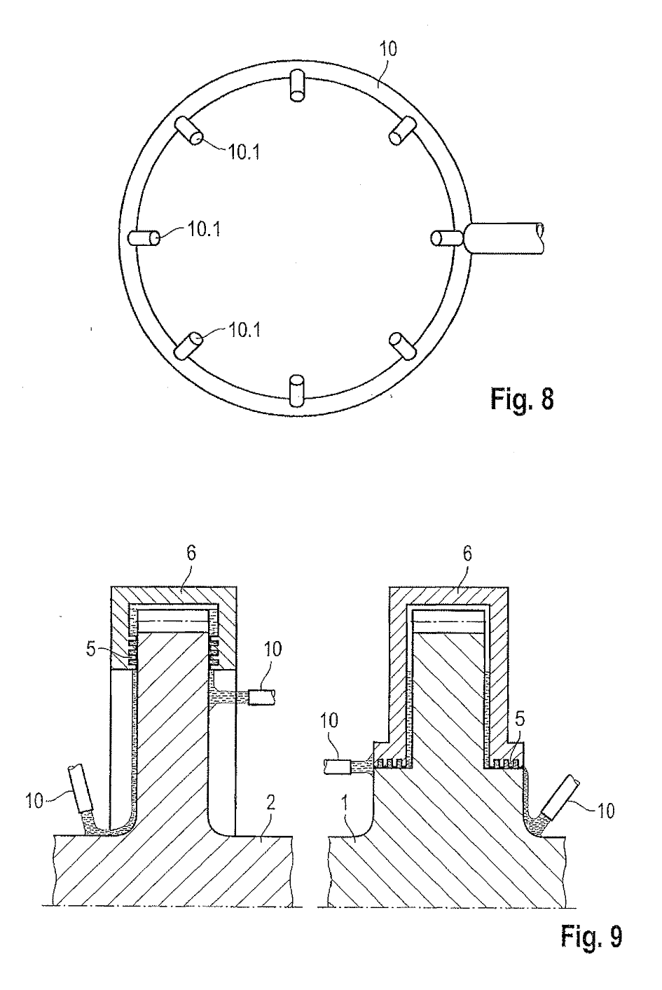

FIG. 8 shows an annular shower for injecting oil in the region of the exit;

FIG. 9 illustrates the oil injection by means of the annular shower according to FIG. 8;

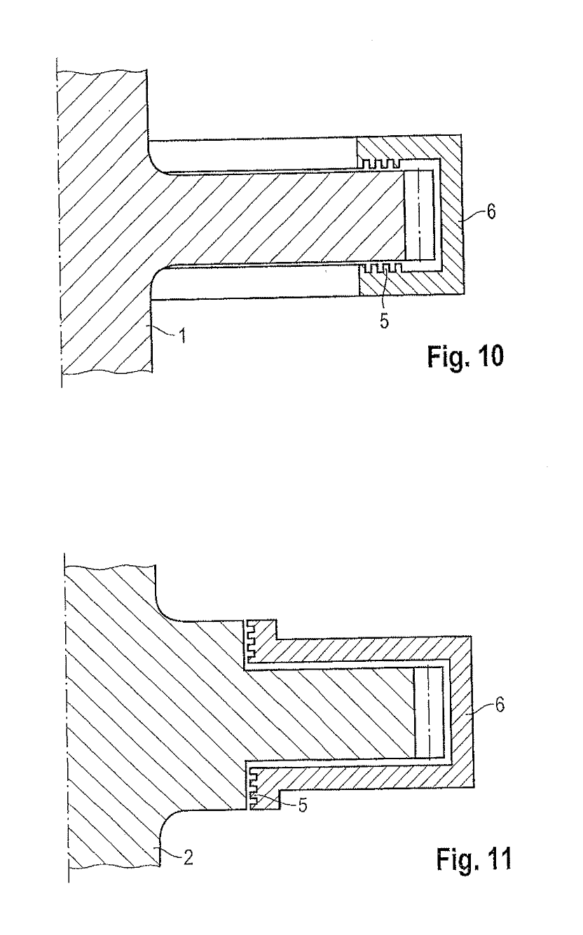

FIGS. 10 and 11 show non-contact seals.

The gear shown in FIG. 1 comprises a first gearwheel 1 and a second gearwheel 2 and a housing 3. The housing 3 comprises an oil drain 3.1.

The two gearwheels 1 and 2 mesh with one another and form an engagement region 4 of the teeth. The engagement region comprises an entrance 4.1 and an exit 4.2. The engagement region 4 is covered by seals 5.

When the two gearwheels revolve as indicated by the curved arrows, a negative pressure is formed in the region of the exit 4.2 and an excess pressure in the region of the entrance 4.1. The seal or seals 5 will seal the overpressure space in a low-friction manner. The sealing can occur axially or radially, e.g. by non-contact labyrinth seals (see FIGS. 10 and 11). A casing wall 6 is provided which tightly encloses the two gearwheels. A narrow gap 7 is formed between the tip circles of the gearwheels 1, 2 and the casing wall 6. The width of the gap 7 can be equal to the tooth height, i.e. the radial extension of each tooth. It can also be a multiple of the tooth height, e.g. between half the tooth height and five times the tooth height.

The casing wall 6 comprises two partial walls 6.1 and 6.2. Partial wall 6.1 forms a negative-pressure space 8 in the exit region of the meshing.

An oil nozzle 10 is provided in the negative-pressure space 8 and a pressure-relief valve 11 on the overpressure space 9. The oil from the oil nozzle 10 is used for lubricating and cooling the system. The negative pressure in the negative-pressure space 8 has a positive effect on the oil conveyance by the oil nozzle 10.

The pressure-relief valve 11 in the overpressure space 9 will open upon exceeding a specific differential pressure between the overpressure space 9 and the remaining interior space which is enclosed by the housing 3. The sealing leakages, the oil supply, the pressure-relief valve flow and the pressure difference are adjusted to each other in such a way that the oil quantity injected from the oil nozzle 10 will flow through the pressure-relief valve 11 into the interior space of the gear and will leave the interior space of the gear through the oil drain 3.1, in order to be cooled, filtered and supplied again to the oil nozzle 10 in the circuit.

The gear according to FIG. 2 comprises a casing wall 6 which is formed by three casing walls 6.1, 6,2 and 6.3. The illustration shows the negative-pressure space 8 again, the oil nozzle 10 and the seals 5. There is no overpressure space however.

The gear according to FIG. 3 is arranged similar to the one according to FIG. 2. It not only lacks the negative-pressure space but also the overpressure space. An oil nozzle is not provided.

In the gear according to FIG. 4 there is neither a negative-pressure space nor an overpressure space, but an oil nozzle 10.

The gear according to FIG. 5 comprises a planet wheel 1 which meshes with a pinion 2. It further comprises two pinions 12 and 13.

The planet wheel 1 and the pinion 2 are associated with a casing wall 6, which in the present case consists of two partial walls 6.1 and 6.2.

FIG. 6 shows an interesting embodiment. Two swivelling flaps 6.1.1 and 6.1.2 are provided. They allow having an influence on the width of the radial sealing gap between the casing wall 6 and the tip circle diameter of the gearwheels. This allows compensating production tolerances and changing the operating mode. The pumping effect of the system can be changed in this way.

FIG. 7 shows a gear with a double-helical gear. Seals are provided on the surfaces of a double helical gearing gap.

The oil nozzle 10 as shown in FIG. 8 is annular. It comprises several nozzles 10.1.

FIG. 9 illustrates the arrangement and function of the oil nozzle 10.

FIGS. 10 and 11 show embodiments of seals.

### LIST OF REFERENCE NUMERALS

1 Gearwheel
2 Gearwheel
3 Housing
3.1 Oil drain
4 Engagement region
4.1 Entrance
4.2 Exit
5 Seal
6 Casing wall
6.1 Partial wall
6.1.1/6.1.2 Swivelling flap
6.2 Partial wall
6.3 Partial wall
6.4 Partial wall
6.5 Outlet
7 Gap
8 Negative-pressure space
9 Overpressure space
10 Oil shower
10.1 Nozzle
11 Pressure-relief valve
12 Pinion
13 Pinion

1-12. (canceled)

13. A fluid-lubricated gear train, comprising the following features:
with at least two gearwheels whose teeth mesh with each other;
with a meshing region which comprises an entrance and an exit;
with a casing wall which encloses the two mutually cooperating gearwheels and partially or fully blocks off the enclosed interior space against the ambient environment;
the casing wall comprises an outlet in the region of the entrance which produces a conductive connection between the interior space and the atmosphere;
the distance between the tip circle of the gearwheels and the casing wall is smaller than the tooth height, with
an overpressure space being provided in the region of the entrance and a negative-pressure space being provided in the region of the exit, and
the overpressure chamber having a pressure-relief valve, with an external housing being provided with an oil drain, said housing enclosing the gearwheels and the casing wall, and
an oil nozzle is provided in the negative-pressure space, so that oil from the oil nozzle is used for lubricating and cooling the gear train, with
the pressure-relief valve being arranged in such a way that it will open upon exceeding a specific differential pressure between the overpressure space and the remaining interior space enclosed by the external housing, and an oil quantity injected from the oil nozzle will flow through the pressure-relief valve into the interior space of the gear and will leave the interior space of the gear via the oil drain in order to be supplied in a circuit to the oil nozzle again.

14. The gear train according to claim 13, characterized in that the connection between the interior space and the atmosphere is a direct one.

15. The gear train according to claim 13, characterized in that the oil shower is provided in the region of the entrance and/or the exit with a nozzle for supplying lubricant to the teeth.

16. The gear train according to claim 14, characterized in that the oil shower is provided in the region of the entrance and/or the exit with a nozzle for supplying lubricant to the teeth.

17. The gear train according to claim 13, characterized in that the casing wall consists of plastic or metal.

18. The gear train according to claim 14, characterized in that the casing wall consists of plastic or metal.

19. The gear train according to claim 15, characterized in that the casing wall consists of plastic or metal.

20. The gear train according to claim 16, characterized in that the casing wall consists of plastic or metal.

21. The gear train according to claim 13, characterized in that the oil drain is pressureless.

22. The gear train according to claim 13, characterized in that the gearwheels are provided with a double-helical gearing.

23. The gear train according to claim 14, characterized in that the gearwheels are provided with a double-helical gearing.

24. The gear train according to claim 15, characterized in that the gearwheels are provided with a double-helical gearing.

25. The gear train according to claim 16, characterized in that the gearwheels are provided with a double-helical gearing.

26. The gear train according to claim 17, characterized in that the gearwheels are provided with a double-helical gearing.

27. The gear train according to claim 18, characterized in that the gearwheels are provided with a double-helical gearing.

28. The gear train according to claim 13, characterized in that a seal is provided in the interior space between the entrance and the exit.

29. The gear train according to claim 22, characterized in that the seal is a brush seal.

30. The gear train according to claim 13, characterized in that the casing wall comprises cooling channels through which a medium of a cooling circuit flows for the dissipation of heat.

31. The gear train according to claim 30, characterized in that the medium is water.

32. The gear train according to claim 13, characterized in that interior space is aspirated.
